(19) United States
(12) Patent Application Publication
(10) Pub. No.: US 2006/0136650 A1
(43) Pub. Date: Jun. 22, 2006

(54) Data-read and write method of bridge interface

(76) Inventors: Jyh-Hwang Wang, Hsinchu (TW); Sheng-Zhong Shieh, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/012,090

(22) Filed: Dec. 16, 2004

(51) Int. Cl. G06F 13/20

(52) U.S. Cl. 710/313

(57) ABSTRACT

The present invention provides a data-read/write method of a bridge interface, which via appropriately controlling the signal level and the timing between the host system and the device, enables the bridge interface to have a complete information handshake, so that the bridge interface can work at any transferring speed and easily transform any instruction stream coming from a front bus. Accordingly, the present invention has the advantages of high compatibility and easiness of transforming instruction streams.

### BACKGROUND OF THE INVENTION

1. Field of The Invention

The present invention relates to a bridge interface, particularly to a data-read/write method of a bridge interface.

2. Description of Related Art

Owing to popularity of the information products, one has many chances to use electronic devices, such as a personal computer, notebook computer, digital camera, printer, scanner, etc., and the communication and signal transference among those electronic devices relies on a communicating interface. Therefore, the transferring speed and the compatibility of a bridge interface become important design subjects thereof.

As to the transferring interfaces bridging two electronic devices, most of those are logic input/output (I/O) ports for general usage and can be divided into the parallel port and the serial port. As to the parallel port, the devices bridged thereby communicate with each other via the address that is configured by the computer system and read out by the operating system, such as the Window 98. Generally speaking, the parallel port in a personal computer comprises three sets of 8-bit registers to perform the reading and writing of the I/O signals. However, as the compatibility and the transferring speed of the interface are not perfect yet, the read/write speed between the host system and the device is still pretty low.

Thus, the present invention provides a data-read/write method of the bridge interface in order to effectively overcome those drawbacks.

### SUMMARY OF THE INVENTION

The primary objective of the present invention is to provide a data-read/write method of a bridge interface in order that the bridge interface can has a complete information handshake and work at any transferring speed.

Another objective of the present invention is to provide a data-read/write method of a bridge interface, which can be easily designed to engage with an existing system and has a high compatibility.

A further objective of the present invention is to provide a bridge interface, which can easily transform any instruction stream coming from a front bus.

According to one aspect of the present invention, a data-write method of a bridge interface can be used in the occasion that a host system writes data into a device via a bus, wherein there are an Initiator Ready channel and a Target Ready channel between the host system and the device. The method comprises the following steps:
(a) driving low the level of a data-output instruction channel, once the level of the Initiator Ready channel is asserted to be high by the host system;
(b) the host's detecting that the Target Ready channel is at a low level, which indicates that the device is ready to receive a piece of data written into by the host;
(c) the host's transferring the piece of data to the device to complete the writing cycle of the first piece of data; then
(d) repeating the step (b) and (c) after completing each individual writing cycle to form a least one cycle, and in the last cycle, interposing a step between the step (b) and (c) to release the level of the data-read/write instruction channel, which has been driven low, in order to inform that the next piece of data is the last one.

Further, according to one aspect of the present invention, a method of utilizing a bridge interface to perform a single data read comprises the following steps:
(a) driving low the level of a data-output instruction channel, once the level of the Initiator Ready channel is asserted to be low by the host system;
(b) the device's placing a piece of data onto the bus;
(c) the host's releasing the level of the data-output instruction channel in order to give up the control over a data-read/write instruction; and
(d) the host's taking the piece of data placed by the device via the bus to complete the reading cycle of one piece of data.

Furthermore, according to one aspect of the present invention, a method of utilizing a bridge interface to perform a multi-data read comprises the following steps:
(a) the host's driving low the level of a data-output instruction channel, once the level of the Initiator Ready channel is asserted to be low by the host system;
(b) the device's driving low the level of a data-input instruction channel in order to take the control over a data-read/write instruction;
(c) the device's placing a piece of data onto the bus;
(d) the host's releasing the level of the data-output instruction channel in order to give up the control over the data-read/write instruction;
(e) the host's taking the piece of data placed by the device via the bus to complete the reading cycle of the first piece of data; and
(f) repeating the step (b), (c) and (e) as the reading cycle of each individual piece of data posterior to the first piece of data after completing each individual reading cycle according to the number of data's pieces to form a plurality of cycles, and in the last cycle, changing the step (b) to be the device's releasing the level of the data-input instruction channel in order to inform the host that the next piece of data is the last one, and then repeating the step (c) and (e) once more.

Via the detailed description of the embodiments stated below in co-operation with the attached drawings, the objectives, technical contents, characteristics and accomplishments of the present invention are to be more easily understood.

### BRIEF DESCRIPTION OF THE DRAWINGS

FIG. 1 is a block diagram of the bridging of the host system and the device according to the present invention.

FIG. 2 is the timing diagram of the single data write according to one embodiment of the present invention.

FIG. 3 is the timing diagram of the multi-data write according to one embodiment of the present invention.

FIG. 4 is the timing diagram of the single data read according to one embodiment of the present invention.

FIG. 5 is the timing diagram of the multi-data read according to one embodiment of the present invention.

### LIST OF REFERENCE NUMERALS

10 bridge interface
12 the host system
14 the device

### DESCRIPTION OF THE PREFERRED EMBODIMENTS

The present invention is to enable a bridge interface, which undertakes a data-reading/writing, to have a complete handshake, via appropriately controlling the signal level and the timing between the host system and the device, so that the bridge interface can work at any transferring speed and easily transform any instruction stream coming from a front bus.

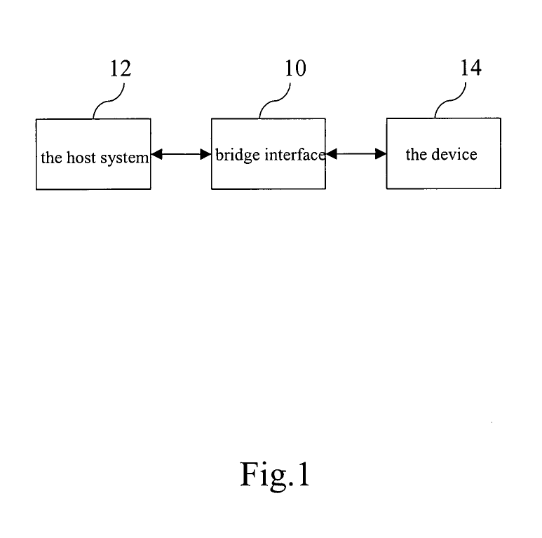

As shown in FIG. 1, the bridge interface 10 of the present invention is a connecting interface between a host system 12 and a device 14, wherein with respect to the hardware, the host system 12 and the device 14 are interconnected by a bus (not shown in the drawing), and via the bus, the host 12 utilizes the bridge interface 10 to read/write a data from/into the device 14. The read/write method of a bridge interface proposed by the present invention includes: a reading-from and a writing-into, wherein the reading-from is divided into a single data read and a multi-data read, and the writing-into is also divided into a single data write and a multi-data write. Those four kinds of embodiments are to be described below in detail.

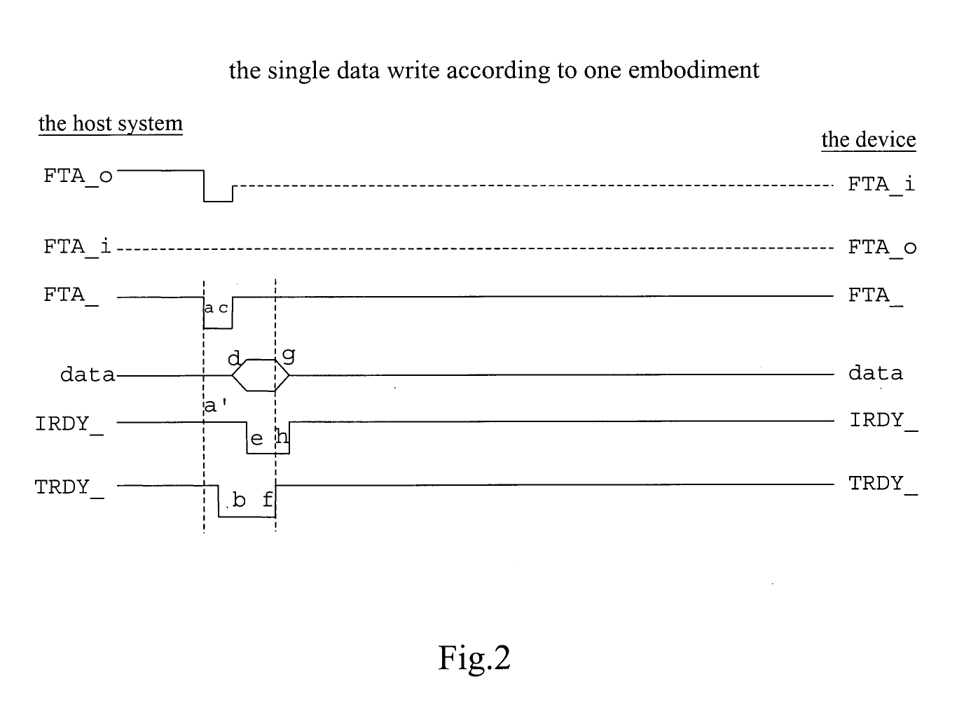

As shown in FIG. 2 the method of the single data write of a bridge interface of the present invention, from the view of the host, the host's action to the data-read/write instruction FTA_ is designated by the data-output instruction channel FTA_o, and the device's action to FTA_ is designated by the data-input instruction channel FTA_i. The IRDY_ or TRDY_ signal is separately driven the Initiator or Target to indicate that the device is ready and the data transference can be undertaken. Besides, FTA_ or the data is usually a bi-directional and tri-state signal, and in parallel with a pull-high resistance.

The method of the single data write of a bridge interface comprises the following steps from the timing a to h as shown in FIG. 2, which are described from the view of the host:
(a) driving low the level of the data-output instruction channel FTA_o, once the level of the Initiator Ready channel IRDY_ is asserted to be high, i.e. at a′;
(b) the host's detecting that the Target Ready channel TRDY_ is at the low level, which indicates that the device is ready to receive a piece of data;
(c) the host's releasing the level of the data-output instruction channel FTA_o to inform that the next piece of data is the last one;
(d) placing the piece of data onto a data bus in the bus;
(e) driving low the level of the Initiator Ready channel IRDY_ to inform the device that the piece of data is ready, once a high level of FTA_ is detected by the host;
(f) the host's detecting that the Target Ready channel TRDY_ is at the high level, which indicates the piece of data has been taken away;
(g) releasing the data bus;
(h) driving high the level of the Initiator Ready channel IRDY_ to inform the device that the data bus has been released.

Thus, the writing-into of all the data is completed. At this time, as the data-read/write instruction FTA_ is at the high level, which indicates that the piece of data is the last one, the device will not drive low the level of the Target Ready channel TRDY_ any more.

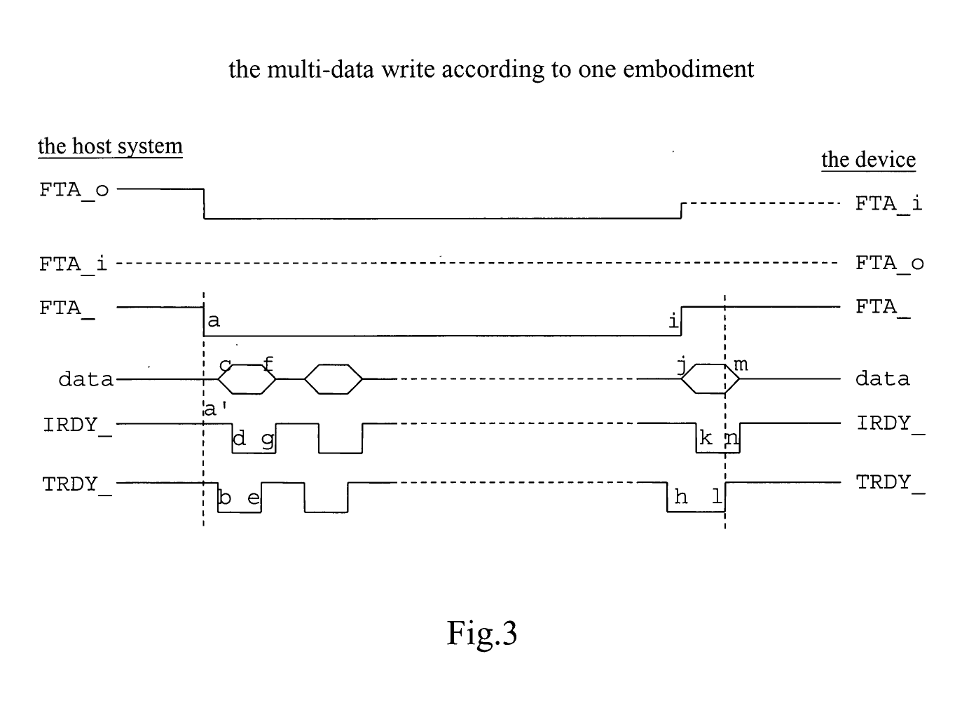

As shown in FIG. 3, the method of the multi-data write of a bridge interface of the present invention comprises the following steps from the timing a to n, which are described from the view of the host:
(a) the host's driving low the level of the data-output instruction channel FTA_o, once the level of the Initiator Ready channel IRDY_ is asserted to be high, i.e. at a′;
(b) the host's detecting that the Target Ready channel TRDY_ is at the low level, which indicates that the device is ready to receive a piece of data;
(c) the device's placing the piece of data onto the bus;
(d) the host's driving low the level of the Initiator Ready channel IRDY_ to inform the device that the piece of data is ready;
(e) the host's detecting that the Target Ready channel TRDY_ is at the high level, which indicates the piece of data has been taken away by the device;
(f) releasing the data bus;
(g) driving high the level of the Initiator Ready channel IRDY_ to inform the device that the data bus has been released, and completing the writing-into of the first piece of data;
(h) the host's detecting that the Target Ready channel TRDY_ is at a low level, which indicates that the device is ready to receive a piece of data;
(i) releasing the data-output instruction channel FTA_o to inform that the next piece of data is the last one;
(j) placing the piece of data onto the data bus;
(k) the host's driving low the level of the Initiator Ready channel IRDY_ to inform the device that the piece of data is ready, once the host detects the high level of FTA_;
(l) detecting that the Target Ready channel TRDY_ is at a high level, which indicates the piece of data has been taken away by the device;
(m) releasing the data bus;
(n) driving high the level of the Initiator Ready channel IRDY_ to inform the device that the data bus has been released, and completing the writing-into of all the data.
   At this time, as the data-read/write instruction FTA_ is at the high level, which indicates that the piece of data is the last one, the device will not drive low the level of the Target Ready channel TRDY_ any more.

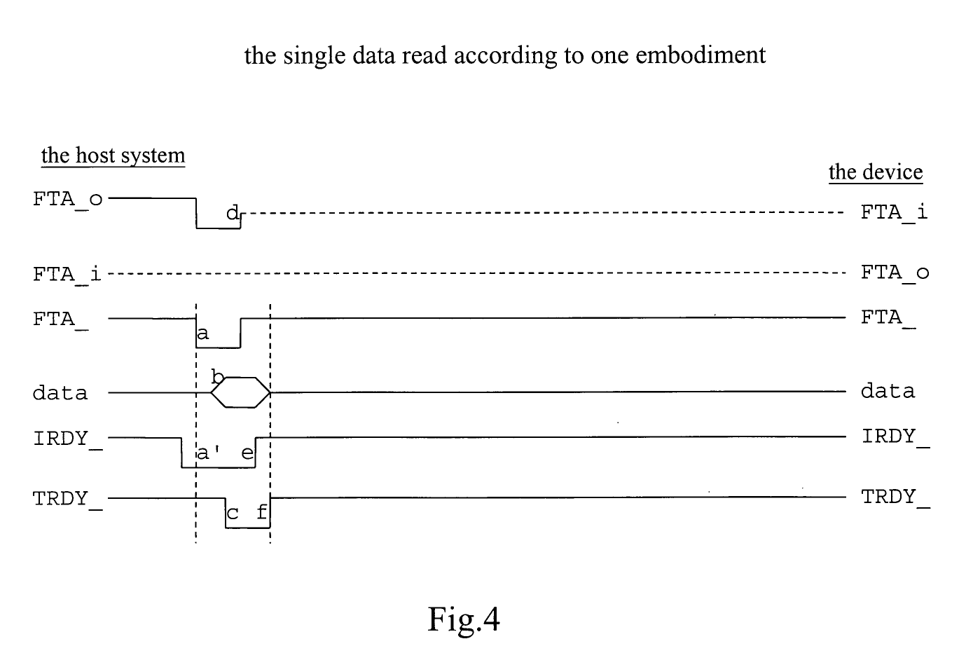

As shown in FIG. 4, the method of the single data read of a bridge interface of the present invention comprises the following steps from the timing a to f, which are described from the view of the host:
(a) the host's driving low the level of the data-output instruction channel FTA_o, once the level of the Initiator Ready channel IRDY_ is asserted to be high, i.e. at a′;
(b) the device's placing a piece of data onto the bus;
(c) the host's detecting that the Target Ready channel TRDY_ is at a low level, which indicates the device has placed the piece of data onto the bus;
(d) the host's releasing the level of the data-output instruction channel FTA_o in order to give up the control over the data-read/write instruction FTA_;
(e) the host's taking the piece of data via the bus, and driving high the level of the Initiator Ready channel IRDY_ to inform the device that the piece of data has been taken away;
(f) the host's detecting that the Target Ready channel TRDY_ is at a high level, which indicates there is only one piece of data.
   As the the data-read/write instruction FTA_ has been at the high level, the piece of data is the last one, and the level of the Initiator Ready channel IRDY_ will not be driven low any more. At this time, the reading-from of all the data is completed.

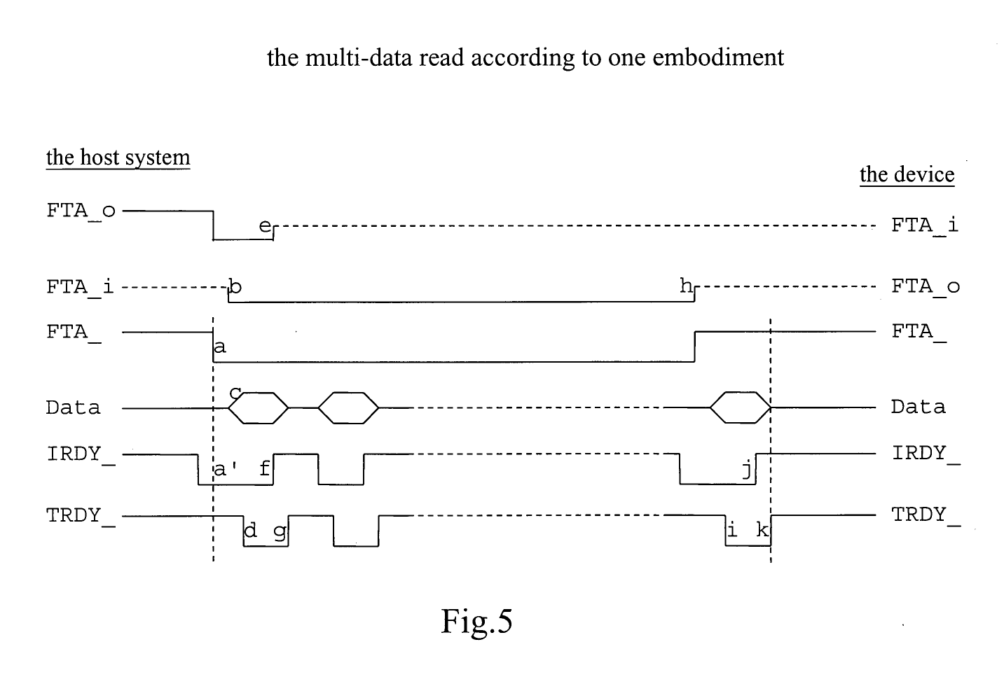

As shown in FIG. 5, the method of the multi-data read of a bridge interface of the present invention comprises the following steps from the timing a to k, which are described from the view of the host:
(a) driving low the level of the data-output instruction channel FTA_o, once the level of the Initiator Ready channel IRDY_ is asserted to be low by the host, i.e. at a′;
(b) the device's driving low the level of the data-input instruction channel FTA_i in order to take the control over the data-read/write instruction FTA_;
(c) the device's placing a piece of data onto the bus;
(d) the host's detecting that the Target Ready channel TRDY_ is at a low level, which indicates that the device has placed the piece of data onto the bus;
(e) the host's releasing the level of the data-output instruction channel FTA_o in order to give up the control over the data-read/write instruction FTA_;
(f) the host's taking the piece of data, and driving high the level of the Initiator Ready channel IRDY_ to inform the device that the piece of data has been taken away, and completing the reading cycle of the first piece of data;
(g) the host's detecting that the Target Ready channel TRDY_ is at a high level, which indicates that the transference of one piece of data has been completed;
(h) the device's releasing the data-input instruction channel FTA_i to inform the host that the next piece of data is the last one;
(i) the host's detecting that the Target Ready channel TRDY_ is at a low level, which indicates that the device has placed a piece of data onto the bus;
(j) the host's taking the piece of data, and driving high the level of the Initiator Ready channel IRDY_ to inform the device that the piece of data has been taken away;
(k) the host's detecting that the Target Ready channel TRDY_ has been at a high level, which indicates that the piece of data is the last one.
   As the data-read/write instruction FTA_ has been at the high level, the host will not drive low the level of the Initiator Ready channel IRDY_ any more. At this time, the reading-from of all the data is completed.

Accordingly, via the bridge interface provided by the present invention, the reading and writing of the data has a complete handshake and can be undertaken at any speed. This method can match with any existing system conveniently and has a high compatibility. Further, via the method of the present invention, the bridge interface can easily transform any instruction stream coming from a front bus.

What is claimed is:

1. A data-write method of a bridge interface, which can be used in the occasion that a host system writes data into a device via a bus, wherein there is an Initiator Ready channel and a Target Ready channel between said host system and said device, and said Initiator Ready channel or said Target Ready channel is separately driven by said host system or said device, comprising the following steps:
(a) said host system's driving low the level of a data-output instruction channel, once the level of said Initiator Ready channel is asserted to be high by said host system;
(b) said host system's detecting that said Target Ready channel is at a low level, which indicates that said device is ready to receive a piece of data written by said host system;
(c) said host system's transferring the piece of data to said device to complete the writing cycle of the first piece of data; and
(d) repeating said step (b) and (c) as the writing cycle of each individual piece of data after completing each individual writing cycle according to the number of the data's pieces to form a least one cycle, and in the last cycle, further interposing a step between said step (b) and (c) to release the level of said data-output instruction channel, which has been driven low, in order to inform that the next piece of data is the last one.

2. The data-write method of a bridge interface according to claim 1, wherein in said step (c), the method of said host system's completing a writing cycle of a piece of data further comprises:
placing said piece of data onto a data bus of said bus;
driving low the level of said Initiator Ready channel to inform said device that the data to be written is ready;
detecting whether the level of said Target Ready channel is high; if yes, indicating that said device has taken away said data; if no, keeping on waiting;
releasing the level of said data bus; and
driving high the level of said Initiator Ready channel to inform said device that said data bus has been released to complete the writing cycle of one piece of data.

3. The data-write method of a bridge interface according to claim 1, wherein said data-output instruction channel and said data are bi-directional signals.

4. The data-write method of a bridge interface according to claim 1, wherein said data-output instruction channel and said data are tri-state signals.

5. The data-write method of a bridge interface according to claim 1, which is applicable to the writing of a single piece or multiple pieces of data.

6. A data-read method of a bridge interface, which can be used in the occasion that a host system reads one piece of data from a device via a bus, wherein there is an Initiator Ready channel and a Target Ready channel between said host system and said device, and said Initiator Ready channel or said Target Ready channel is separately driven by said host system or said device, comprising the following steps:
(a) said host system's driving low the level of a data-output instruction channel, once the level of said Initiator Ready channel is asserted to be low by said host system;
(b) said device's placing said piece of data onto said bus;
(c) said host system's releasing the level of data-output instruction channel in order to give up the control over a data-read/write instruction; and
(d) said host system's taking said data placed by said device via said bus to complete the reading cycle of one piece of data.

7. The data-read method of a bridge interface according to claim 6, wherein between said step (b) and (c), said method further comprises a step of said host system's detecting the low level of said Target Ready channel, which indicates that said device has placed said piece of data onto said bus.

8. The data-read method of a bridge interface according to claim 6, wherein in said step (d), the method of said host system's taking said data, placed by said device, further comprises the following steps:
taking said data, and driving high the level of said Initiator Ready channel to inform said device that said data has been taken away; and
detecting whether the level of said Target Ready channel is high; if yes, indicating that the transference of one piece of data has been completed; if no, keeping on waiting in order to complete the reading cycle of one piece of data.

9. The data-read method of a bridge interface according to claim 6, wherein said data-read/write instruction and said data are bi-directional signals.

10. The data-read method of a bridge interface according to claim 6, wherein said data-read/write instruction and said data are tri-state signals.

11. A data-read method of a bridge interface, which can be used in the occasion that a host system reads multiple pieces of data from a device via a bus, wherein there is an Initiator Ready channel and a Target Ready channel between said host system and said device, and said Initiator Ready channel or said Target Ready channel is separately driven by said host system or said device, comprising the following steps:
(a) said host system's driving low the level of a data-output instruction channel, once the level of said Initiator Ready channel is asserted to be low by said host system;
(b) said device's driving low the level of a data-input instruction channel in order to take the control over a data-read/write instruction;
(c) said device's placing said multiple pieces of data onto said bus;
(d) said host system's releasing the level of said data-output instruction channel in order to give up the control over said data-read/write instruction;
(e) said host system's taking said piece of data to complete the reading cycle of the first piece of data; and
(f) repeating said step (b), (c) and (e) as the reading cycle of each individual piece of data posterior to the first piece of data after completing each individual reading cycle according to the number of the data's pieces to form a plurality of cycles, and in the last cycle, changing said step (b) to be releasing the level of said data-input instruction channel in order to inform said host system that the next piece of data is the last one, and then repeating said step (c) and (e) once more.

12. The data-read method of a bridge interface according to claim 11, wherein between said step (c) and (d), said method further comprises a step of said host system's detecting the low level of said Target Ready channel, which indicates that said device has placed said piece of data onto said bus.

13. The data-read method of a bridge interface according to claim 11, wherein in said step (e), the method of said host system's taking said data, placed by said device, further comprises the following steps:
taking said data, and driving high the level of said Initiator Ready channel to inform said device that said data has been taken away; and
detecting whether the level of said Target Ready channel is high; if yes, indicating that the transference of one piece of data has been completed; if no, keeping on waiting in order to complete the reading cycle of one piece of data.

14. The data-read method of a bridge interface according to claim 11, wherein said data-read/write instruction and said data are bi-directional signals.

15. The data-read method of a bridge interface according to claim 11, wherein said data-read/write instruction and said data are tri-state signals.
